(19) United States
(12) Patent Application Publication
(10) Pub. No.: US 2002/0016197 A1
(43) Pub. Date: Feb. 7, 2002

(54) Internet sweepstakes system and method

(76) Inventor: Craig Candelaria, Costa Mesa, CA (US)

Correspondence Address: LAW OFFICES OF CLEMENT CHENG, CLEMENT CHENG, ESQ., DAIMLER CHRYSLER BUILDING, 7700 IRVINE CENTER DRIVE #710, IRVINE, CA, 92618, US

(21) Appl. No.: 09/901,170

(22) Filed: Jul. 9, 2001

Related U.S. Application Data
(60) Provisional application No. 60/218,395, filed on Jul. 14, 2000.

(51) Int. Cl. A63F 13/00

(52) U.S. Cl. 463/16; 463/42; 705/14; 700/91

(57) ABSTRACT

an internet sweepstakes method comprising the steps of: registration of website users into a user registrar; picking winner names from a user registrar; displaying at least one winner name on said website; identification of said users when they visit said website; allowing a winner to claim a prize by clicking a link, wherein said winner is a user who can only claim a prize when said user name is displayed on said website; modifying at least one said at least one winner name after a predetermined time where the prize is unclaimed.

### FIELD OF INVENTION

This invention relates to the field of electronic sweepstakes and electronic advertising.

### DESCRIPTION OF RELATED ART

Sweepstakes are an age-old method to attract customer attention. Impulse and emotion are driving factors by which people alleviate their pains, fears and desires. The question of “What if?” plays heavily on the curious nature of people in general. This is one of the reasons that television shows like “Who wants to be a Millionaire,” “Survivor” and “Big Brother” command such high ratings. Publishers Clearinghouse relies on the “What if?” factor to entice millions of people to order magazines and/or enter their sweepstakes promotions. With notices bearing wording such as “If you do not enter and your number is selected your prize is forfeited,” people are further prompted to give it a try just in case.

The Internet has enabled access to vast amounts of content. In order for companies that rely on high Internet traffic and a strong user base to be profitable they must both bring traffic to their site and to keep them at their site. Some tactics include below cost pricing, free shipping and cash and/or prizes. With much competition on the Internet it is hard to find a profitable business model as a better deal may be one mouse click away. Internet companies have failed and a profitable Internet company is hard to find.

Many sites have a sweepstakes. Sites currently using sweepstakes to increase traffic lack an added sense of urgency. Currently, a user can visit a sight and blindly navigate requisite pages to be entered in a daily drawing. Users also have no way of knowing if they won and lack any kind of realistic expectation of winning. Users do not know who is winning and often times feel that the process is entirely out of their control and random. Users lack the ability to increase their chances of winning.

### OBJECT OF THE INVENTION

The website enabled with the invention will allow a user client to register at the site. With the website offers the user the opportunity to win a prize. Prizes are distributed at random. When a user has won a prize the only way to claim said prize is by visiting the Web site and seeing a notice that said a user has won a prize. This builds user loyalty and offers a greater level of interaction.

### DESCRIPTION OF THE PREFERRED EMBODIMENT

The invention is a sweepstakes program that can be hosted from a webserver. A Visitor at a participating website can register to participate in the sweepstakes. When a visitor registers to become a client, also called user, the local webserver can take the participant's information and store it in a database. Alternatively, the user can register at a common and central database to save time in registering at numerous participating sites to participate at. In any case, the registration scheme can be done either way. The next time the user visits a participating website, they can either have an identifier such as a cookie or they can participate while logged in to the website. Many websites have users that must login or otherwise be identified or verified in order to receive access to certain site functionality.

When a client logs in or is simply visiting, the site contains a dynamic link featuring the name of a winner. The link can be text, graphics or an animation. If a sweepstakes client such as Clem Cheng is named as the winner, he can click the link and enter a verification password to claim a prize. In this case, Clem just redeemed or claimed his prize as opposed to abandoning it. If the winner does not claim the prize, the dynamic link is changed so that another name appears. The banner can change location so that people do not become accustomed to looking in a particular location for the banner.

The website need only contain a link to the sweepstakes server. Thus, any site that can display a rudimentary link can offer a sweepstakes. The sweepstakes server has a list of graphics and named winners. The graphics and named winners rotate at random or by predefined periods. Currently, the best mode has been to change the names one hour at a time. Also, five winners can be posted and the prize given to the first three to click through. A graphical banner is the preferred means of displaying the names because it does not necessarily contain text that can be automatically monitored. A graphical banner requires the user to actually visit the website and pay attention to the screen to win.

Once the winner clicks on the banner, she can go to the server site. An entirely unrelated sweepstakes management company such as Panquake Inc. should operate the server as this would be a more efficient use of computing resources. On the other hand, the sweepstakes can be locally managed to offer a higher level of security, privacy and anonymity. Once the user is at the server, the user logs in and enters his verification password. The user then receives the prize from the sweepstakes management company. The sweepstakes management company may post the user's picture and prize won on the website. The sweepstakes management company can also collect information about users such as their name, age and occupation etc. This sweepstakes may require “opt in” permission before registering a visitor as a user. Other verifications such as email authentication can decrease the number of false or impersonated users.

The randomizer can be weighted towards users that are logged in or not logged in. It can also favor certain users at random.

The invention application will require the user to be at the site at the right time and paying attention to what he or she is viewing. The thrill of possibly seeing their name on the page and winning some type of reward coupled with the fear of not being at the site when their name came up and missing out will play heavily on a users mind when surfing the web.

A user can claim a prize in many ways. For example, a site may feature a banner showing his name. In this case, the user can click on the banner and claim the prize. The prize may be a discount on a particular item. It behooves the user to constantly visit the site and view the site in order to increase his chances of winning. Usually the user will another person's name on a website. Showing the current prizewinner also promotes a sense possibility of winning.

Internet retailers can use this application to offer special discounts to random members or all members at specific times. This will be an added draw to both gather a membership list and maintain high membership traffic to the site. Applicant understands that various variations of membership based sweepstakes methods of enticing an audience has been used on radio and is still one of the top promotions used today. The advantage of using it on the Internet is that the actual usage and traffic can be monitored and tracked with unprecedented precision.

By providing the service of posting and verifying member names to sites the generation of a customer base is intensified. Sites will be able to use this application in tandem with traditional advertisements and enticements with the added feature of playing on the “What if?” factor.

### PARTICULAR IMPLEMENTATION

A particular implementation called Panquake is provided in the design specification prepared on Jun. 18, 2001. A team of programmers assisted in reducing the invention to practice. The particular architectural style of the programming and is considered to be the best of all of the invention at the time of the design specification. This implementation is believed to be the best mode at this point, and may change shortly.

E Commerce is volatile business; every day sites are added to the World Wide Web and many fail. The objective of the Panquake software system is to increase site traffic and customer loyalty by providing a pool that allows subscribers, also called clients, to offer prizes and other incentives. The invention is a Web based system that allows Internet users to easily participate in the contest offered by clients, with the simple click of a mouse. Three types of users interact with this system: Internet users, clients, and administrators. Clients purchase sweepstakes services and link the banner on their existing web page. Internet users, enticed by the chance to win a free prize, enter the contest via the banner, and most frequent the sites to check if their name is displayed. The banner is for 68 by 60 pixels. As the banner displays a name that is randomly selected every N hours from a pool of users. A user must claim the prize within a certain number of hours of their name being displayed by logging into the system.

1. an internet sweepstakes method comprising the steps of:
a. registration of website users into a user registrar;
b. picking winner names from a user registrar;
c. displaying at least one winner name on said website;
d. identification of said users when they visit said website;
e. allowing a winner to claim a prize by clicking a link, wherein said winner is a user who can only claim a prize when said user name is displayed on said website;
f. modifying at least one said at least one winner name after a predetermined time where the prize is unclaimed.

2. an internet sweepstakes system having:
a. a user registrar housed on a web server;
b. user names contained within said user registrar;
c. a name randomizer able to pick at least one winner name at random from said user names;
d. a means to display said at least one winner name to website visitors;
e. a link means allowing a winner a limited time to claim a prize;
f. a user identification and verification means to allow only a winner to claim a prize.

3. an internet sweepstakes system having:
a. a user registrar housed within a database;
b. a list of user names housed within said user registrar;
c. a name randomizer able to pick one or more winner names at random from said list of user names;
d. a display capable of showing one or more winner names on a website, said one or more winner names picked by said name randomizer;
e. a link allowing prize claiming by a user having a displayed winner name;
f. a user identification means, wherein a user must type in a login name and a password to verify identity.

4. the internet sweepstakes system of claim 3 wherein element
f. is a user identification means, wherein a cookie residing on a user's computer automatically identifies said user.

5. the internet sweepstakes system of claim 3 wherein element
f. is a user identification means, wherein a cookie residing on a user's computer automatically identifies said user, wherein said display does not show a winner name.

6. the internet sweepstakes system of claim 3 wherein element
f. is a user identification means, wherein a cookie residing on a user's computer automatically identifies said user, wherein said display shows one or more winner names on a website.
